(19) United States
(12) Patent Application Publication
(10) Pub. No.: US 2022/0348114 A1
(43) Pub. Date: Nov. 3, 2022

(54) POWER DRIVING MODULE FOR SWIVEL SEAT

(71) Applicant: DAS CO., LTD., Gyeongju-si (KR)

(72) Inventors: Kwang Sin LEE, Hwaseong-si (KR); Jeong Hyun Lim, Suwon-si (KR)

(21) Appl. No.: 17/585,716

(22) Filed: Jan. 27, 2022

(30) Foreign Application Priority Data
Apr. 30, 2021 (KR) 10-2021-0056385

(51) Int. Cl. B60N 2/02; B60N 2/14

(52) U.S. Cl. CPC B60N 2/0232; B60N 2/14; B60N 2002/0236

(57) ABSTRACT

Disclosed herein is a power driving module for a swivel seat. The power driving module rotatably drives a rotating frame with respect to a fixed frame. The power driving module includes: a driving motor installed on the fixed frame; a deceleration unit configured to decelerate and transmit a provided driving force in conjunction with the driving motor; and a ring gear configured to rotate the rotating frame in a forward or reverse direction in conjunction with the deceleration unit; wherein the driving motor includes a hollow output member disposed coaxially with the rotation center of the rotating frame, the ring gear is disposed concentrically with the rotation center of the rotating frame, and the deceleration unit is disposed in a radial structure around the output member of the driving motor.

### CROSS-REFERENCE TO RELATED APPLICATION

This application claims priority from and the benefit of Korean Patent Application No. 10-2021-0056385, filed on Apr. 30, 2021, which is hereby incorporated by reference for all purposes as if fully set forth herein.

### BACKGROUND

### 1. Technical Field

The present invention relates generally to a power driving module for a swivel seat, and more particularly to a power driving module for a swivel seat in which the output member of a driving motor is formed as a hollow structure and cables for motor operation control are wired to the outside through the hollow structure, so that the interference of the cables with surrounding rotating portions may be prevented, and in which a deceleration unit is concentrically disposed in a radial structure around the output member of the driving motor, so that a rotating frame may be guided through more stable rotation and the utilization of space may be increased.

### 2. Description of the Related Art

With the improvement of eco-friendly, smart, autonomous driving technology, the trend is changing such that vehicle seats can be used for various activities in addition to driving. In particular, a demand for convenience for free space arrangement through the rotation of a seat to form a comfortable interior space for a vehicle is raised, and a swivel seat has been developed to meet the demand.

Furthermore, when a user rotates a swivel seat within the inside of a vehicle, it is inconvenient for the user to manually operate the swivel seat, so that usability and convenience are degraded. Accordingly, there is a growing demand for a power-driven rotating device that allows a user to rotate a seat to a desired position after or before boarding.

Meanwhile, a conventional power driving module for a swivel seat is provided with a deceleration unit using a worm gear and a worm wheel in order to prevent the reverse rotation of the seat against the rotational force provided from a driving motor, as disclosed in Korean Patent No. 10-1997869.

In this conventional power drive module for a swivel seat, a driving motor and a deceleration unit are not coaxially arranged, the rotation shaft of the driving motor and the output shaft of the deceleration unit intersect each other at an angle of approximately 90 degrees, and cables for the control of the operation of the motor are rotated dependently according to the rotational direction of the seat. Accordingly, when a swivel seat is rotated, twisting occurs in the cables, thereby causing damage to the cables. Above all, since the driving motor and the deceleration unit are not coaxially arranged, the utilisation of space is degraded, with the result that a disadvantage arises in that the overall size of the seat cannot be made compact

### SUMMARY

An object of the present invention is to provide a power driving module for a swivel seat in which the output member of a driving motor is formed as a hollow structure and cables for motor operation control are wired to the outside through the hollow structure of the output member, so that the interference of the cables with surrounding rotating portions may be prevented, thereby fundamentally preventing damage to the cables attributable to twisting resulting from the rotation of the swivel seat

Another object of the present invention is to provide a power driving module for a swivel seat in which the output member of a driving motor is disposed coaxially with the rotation center of a rotating frame and a deceleration unit is disposed in a radial structure with respect to the output member of the driving motor, so that the rotating frame may be guided through more stable rotation, the utilization of space may be increased, and the overall size of the swivel seat may be made compact.

In order to accomplish the above objects, the present invention provides a power driving module for a swivel seat, the power driving module rotatably driving a rotating frame with respect to a fixed frame, the power driving module including: a driving motor installed on the fixed frame; a deceleration unit configured to decelerate and transmit a provided driving force in conjunction with the driving motor; and a ring gear configured to rotate the rotating frame in a forward or reverse direction in conjunction with the deceleration unit; wherein the driving motor includes a hollow output member disposed coaxially with the rotation center of the rotating frame, the ring gear is disposed concentrically with the rotation center of the rotating frame, and the deceleration unit is disposed in a radial structure around the output member of the driving motor.

The fixed frame may include a base plate provided with a hollow boss portion, the hollow output member may include a rotor rotatably installed on the outer circumferential surface of the hollow boss portion of the base plate and a stator disposed around the rotor and fixed to the base plate, and the rotor may be provided with a first worm gear on the outer circumferential surface thereof to transmit a driving force to the deceleration unit.

A bearing may be installed on the outer circumferential surface of the hollow boss portion of the base plate, and the rotor may be rotatably installed on the outer circumferential surface of the hollow boss portion of the base plate via the bearing.

The deceleration unit may include: a first deceleration part configured to firstly decelerate and transmit the rotation of the rotor; a second deceleration part configured to secondly decelerate and transmit the rotation of the first deceleration part; and a third deceleration part configured to thirdly decelerate the rotation of the second deceleration part and transmit it to the ring gear.

The first deceleration part may include a first worm wheel configured to come into external contact with and operate in conjunction with the first worm gear; the second deceleration part may include a second worm wheel configured to come into external contact with and operate in conjunction with a second worm gear disposed coaxially with the first worm wheel, and a pinion gear disposed coaxially with the second worm wheel; the third deceleration part may include a ring gear configured to come into external contact with and operate in conjunction with the pinion gear; and the ring gear may be disposed on the bottom surface of the load support member to be disposed concentrically with the rotation center of the rotating frame.

The power driving module may further include a shaft member configured to allow the first worm wheel and the second worm gear to be coaxially disposed; both ends of the shaft member may be rotatably installed onto mounting brackets; and the mounting brackets may be fixed to a housing to which the base plate is coupled.

The mounting brackets may include a set screw fastened to adjust an axial position with respect to the shaft member, and the set screw may be configured to minimize backlash between the second worm gear and the second worm wheel by variably adjusting the axial position of the shaft member with respect to the mounting brackets.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a perspective view showing a power driving module for a swivel seat according to an embodiment of the present invention;

FIG. 2 is a sectional view illustrating the coupling relationship between all the components of the power driving module for a swivel seat shown in FIG. 1;

FIG. 3 is an exploded perspective view showing a deceleration unit that is located inside with only a load support member separated from a housing in the power driving module for a swivel seat according to an embodiment of the present invention;

FIG. 4 is an exploded bottom perspective view showing the disassembled state of FIG. 3, which shows the arrangement of a pinion gear located on the circumference of the bottom surface of the load support member;

FIG. 5 is an exploded perspective view of the overall configuration of a power driving module for a swivel seat according to an embodiment of the present invention in isolation; and

FIG. 6 is a diagram schematically showing a state in which cables electrically connecting a driving motor and a controller are exposed to the outside through the boss portion of a base plate in a power driving module for a swivel seat according to an embodiment of the present invention.

### DETAILED DESCRIPTION

Preferred embodiments of the present invention will be described in detail below with reference to the accompanying exemplary drawings.

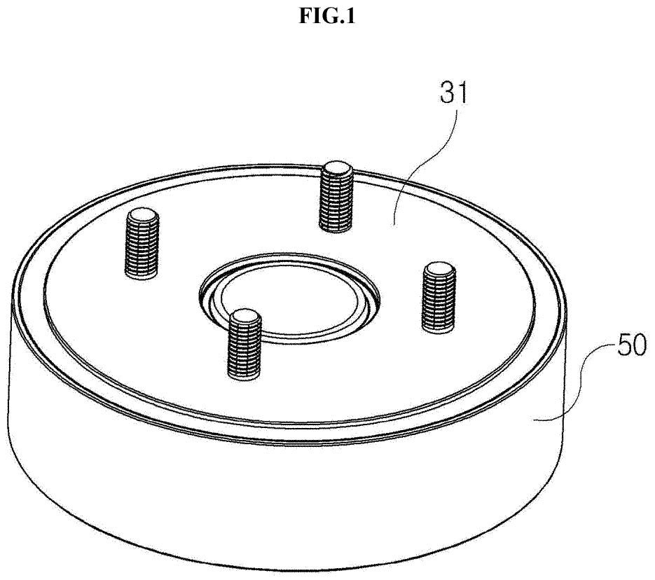

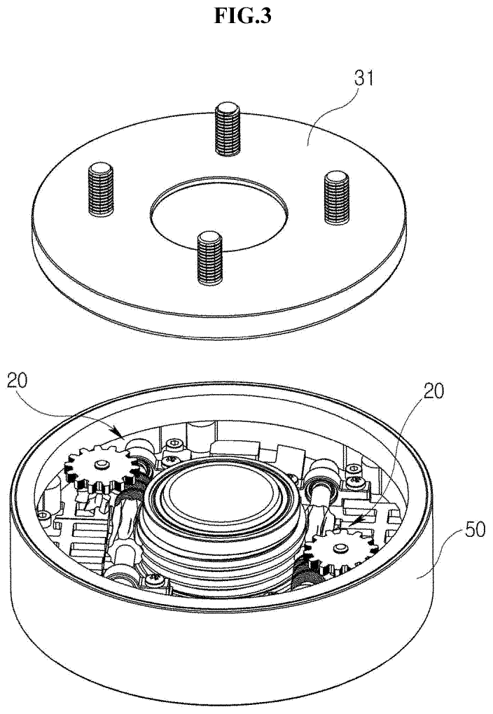

Referring to FIGS. 1 to 6, a power driving module for a swivel seat according to an embodiment of the present invention is applied to a fixed frame (not shown) fixedly installed on a floor panel within the inside of a vehicle, and a rotating frame (not shown) installed to support the load of the seat with respect to the fixed frame. The power driving module for a swivel seat serves to operate the rotating frame so that the rotating frame is rotated in a desired direction with respect to the fixed frame in response to a user's manipulation.

The power driving module includes a driving motor 10 installed in the fixed frame, a deceleration unit 20 configured to appropriately decelerate and transmit the driving force provided from the motor while operating in conjunction with the driving motor 10, and a ring gear 30 configured to rotate the rotating frame in a forward or reverse direction with respect to the fixed frame while operating in conjunction with the deceleration unit 20.

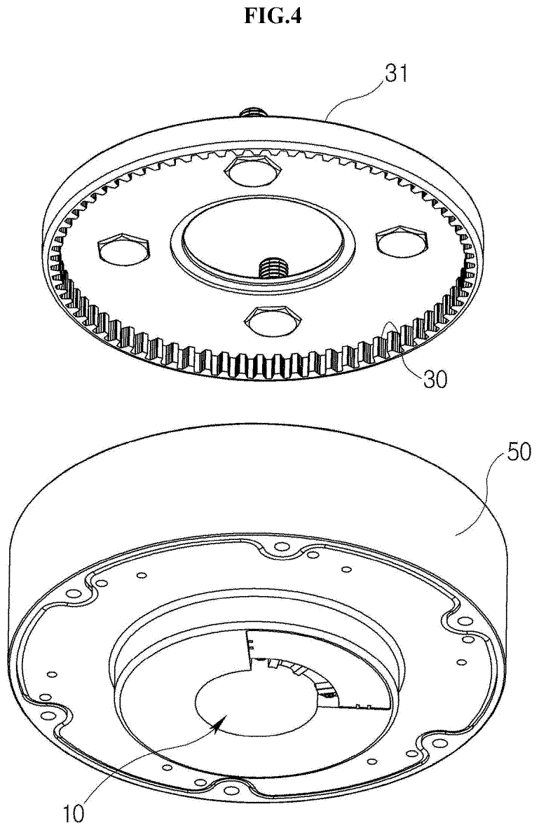

In this case, the ring gear 30 is a member that transmits a direct rotational force to the rotational frame for the rotation of the rotating frame with respect to the fixed frame, and is configured to be disposed coaxially with the rotational center of the rotating frame. For example, as shown in FIG. 4, the ring gear 30 may be configured to be concentrically arranged along the overall circumference of the bottom of a load support member 31 formed of a disk-shaped member coupled to the bottom of the swivel seat. In other words, the ring gear 30 is a member configured to rotatably install the rotating frame. The ring gear 30 is a member that finally implements rotation with respect to the swivel seat by receiving the rotational force provided from the driving motor 10 through the deceleration unit 20 and then providing it to the load support member 31.

The driving motor 10 is fixedly installed to the fixed frame, and includes a hollow output member disposed coaxially with the rotation center of the rotating frame.

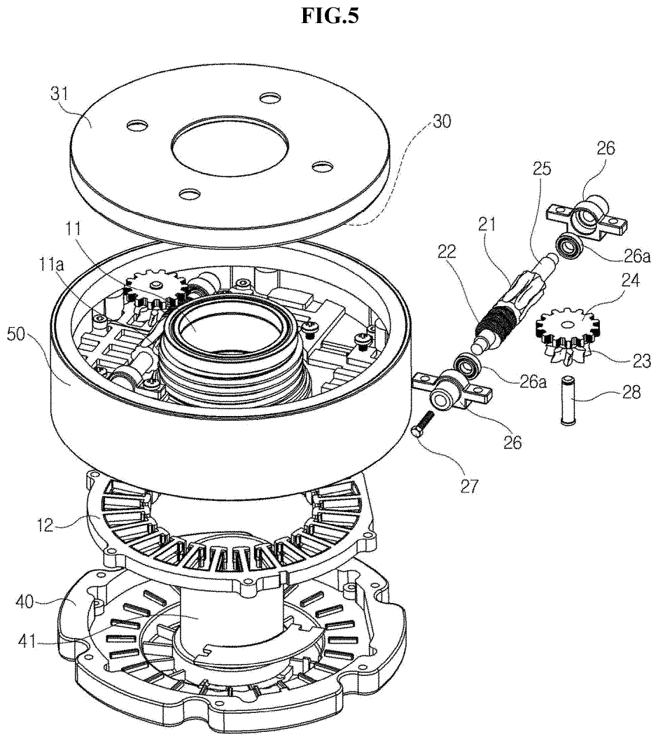

The hollow output member is configured to include a rotor 11 rotatably installed coaxially with respect to the outer circumferential surface of the hollow boss portion 41 of the base plate 40, and a stator 12 disposed on the circumference of the rotor 11 and fixed to the base plate 40, as shown in FIG. 5. In this case, the rotor 11 is configured to be integrated with a first worm gear 11 a on the outer circumferential surface thereof in order to transmit a driving force to the deceleration unit 20.

The fixed frame includes a base plate 40 having a hollow boss portion 41 that protrudes upward to an appropriate length, as shown in FIG. 5. In an embodiment of the present invention, the base plate 40 may be configured to be rigidly fixed to the top portion of the fixing frame in the state in which it is coupled to the bottom of a cylindrical housing 50. In this case, the boss portion 41 of the base plate 40 acts as a type of wire guarder that is connected to a controller and accommodates and protects a power line and signal lines that provide power and control signals required for the forward and reverse rotation of the driving motor 10.

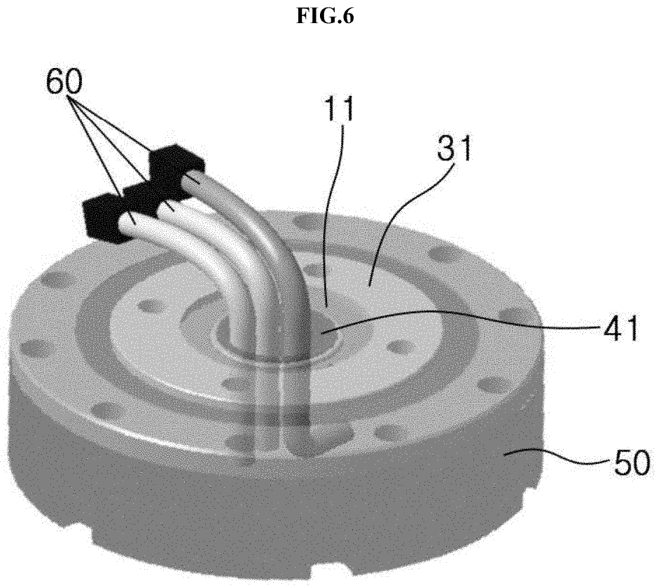

In other words, various cables 60 including the power and signal lines electrically connecting the driving motor 10 and the controller are accommodated inside the bosses 41 of the base plate 40, as shown in FIG. 6. The cables 60 are protected from interference even when the rotating frame is rotated with respect to the fixed frame. Accordingly, the cables 60 are not damaged by twisting. Through this, the driving motor 10 may secure the stable rotational operation of the swivel seat by avoiding risks such as erroneous operation or the deterioration of safety.

In addition, the controller configured to control the operation of the driving motor 10 may be installed to be seated and supported on the base plate 40.

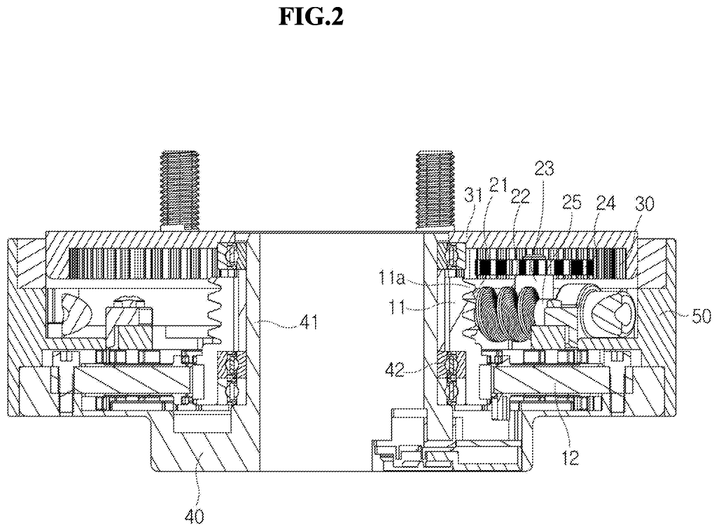

In addition, the hollow boss portion 41 of the base plate 40 is configured such that a bearing 42 is installed on the outer circumferential surface thereof and the rotor 11 is installed in the state in which the rotation is free from the outer circumferential surface of the hollow boss part 41 of the base plate 40 via the bearing 42, as shown in FIG. 2. In other words, the boss portion 41 of the base plate 40 is configured such that the bearing 42 is mounted on the outer circumferential surface in order to rotatably install the rotor 11.

The deceleration unit 20 includes a first deceleration part configured to firstly decelerate and transmit the rotation of the rotor 11, a second deceleration part configured to secondly decelerate and transmit the rotation of the first deceleration part, and a third deceleration part configured to thirdly decelerate the rotation of the second deceleration part and transmit it to the ring gear 30, as shown in FIGS. 2, 3 and 5, respectively.

In particular, it will be more preferable that the deceleration unit 20 be arranged around the output member of the driving motor 10 in a radial structure. In other words, the deceleration unit 20 may include a plurality of deceleration parts that are provided in a radial structure based on the rotation center of the rotor 11 corresponding to the output member of the driving motor 10. As a result, the rotational force generated from the rotor 11 of the driving motor 10 may be transmitted to the load support member 31 through the plurality of deceleration parts arranged in a radial structure, and the rotational force transmitted to the load support member 31 may stably rotate the seat surface of the swivel seat through the rotating frame.

For this purpose, an embodiment of the first, second, and third deceleration parts constituting the deceleration unit 20 will be described in detail as follows:

As shown in FIG. 5, the first deceleration part includes a first worm wheel 21 configured to come into external contact with and operate in conjunction with the outer circumferential surface of the first worm gear 11.

As shown in FIG. 5, the second deceleration part includes a second worm wheel 23 configured to come into external contact with and operate in conjunction with the outer circumferential surface of the second worm gear 22 that is disposed coaxially with the first worm wheel 21, and a pinion gear 24 disposed coaxially with the second worm wheel 23.

As shown in FIG. 5, the third deceleration part includes a ring gear 30 configured to come into external contact with and operate in conjunction with the outer circumferential surface of the pinion gear 24. In this case, as shown in FIG. 4, the ring gear 30 is configured to be arranged concentrically with respect to the rotation center of the load support member 31 corresponding to the rotating frame coupled to the bottom surface of the swivel seat

In addition, the first worm wheel 21 and the second worm gear 22 are spaced apart from each other at an appropriate interval coaxially with a single shaft member 25, as shown in FIG. 5. In this case, both ends of the single shaft member 25 on which the first worm wheel 21 and the second worm gear 22 are arranged are rotatably installed into mounting brackets 26. Furthermore, the mounting brackets 26 are fixedly installed to a housing 50 to which the base plate 40 is coupled. Furthermore, each of the mounting brackets 26 includes a bearing 26a configured to rotatably support the single shaft member 25 on which the first worm wheel 21 and the second worm gear 22 are arranged.

In addition, the shaft member 25 is configured such that the axial position thereof is variably adjusted by a set screw 27 fastened to the mounting bracket 26, as shown in FIG. 5. In other words, as the set screw 27 variably adjusts the axial position of the shaft member 25 with respect to the mounting bracket 25, it serves to minimize the backlash occurring between the second worm gear 22 and the second worm wheel 23 or between the pinion gear 24 and the ring gear 30.

Meanwhile, the second worm wheel 23 and the pinion gear 24 are also coaxially arranged to be spaced apart from each other at an appropriate interval. For example, the coaxial arrangement of the second worm wheel 23 and the pinion gear 24 is implemented by rotatably disposing the second worm wheel 23 and the pinion gear 24 via a pin member 28 fixed to the housing 50, as shown in FIG. 5.

Therefore, in the power driving module for a swivel seat according to the embodiment of the present invention, which is configured as described above, the output member of the driving motor 10 is disposed coaxially with the rotation center of the rotating frame, and the output member of the driving motor 10 is set to the boss portion 41 of the base plate 40 in a hollow structure. Accordingly, the cables 60 corresponding to the power lines and signal lines of the driving motor 10 may be externally wired through the hollow structure formed by the boss portion 41 of the base plate 40, which is an output member. As a result, it may be possible not only to more actively avoid interference between the cables 60 and their surrounding components, but also to fundamentally prevent damage from the twisting of the cables 60 when the swivel seat is rotated. Through this, the driving motor 10 may secure the stable rotational operation of the swivel seat by avoiding risks such as erroneous function or the deterioration of safety.

In addition, the power driving module for a swivel seat according to an embodiment of the present invention may include a plurality of power driving modules that have a radial structure with respect to the output member of the driving motor 10 in which the deceleration unit 20 is disposed coaxially with the rotation center of the rotation frame. Accordingly, the rotational force generated from the rotor 11 of the driving motor 10 may be transmitted to the load support member 31 through the plurality of deceleration parts 20 arranged in a radial structure. Through this, the rotational force transmitted to the load support member 31 may allow the smooth rotational operation of the swivel seat while maintaining the rotation of the rotational frame with respect to the fixed frame more stably. Furthermore, the utilization of space for the installation of parts may be increased, and the overall size of the seat may be made compact.

In the power driving module for a swivel seat according to the embodiment of the present invention, the output member of the driving motor is formed as the hollow structure and the cables for motor operation control are wired to the outside through the hollow structure of the output member, so that the interference of the cables with the surrounding rotating portions may be prevented, thereby fundamentally preventing damage to the cables attributable to twisting resulting from the rotation of the swivel seat

In the power driving module for a swivel seat according to the embodiment of the present invention, the output member of the driving motor is disposed coaxially with the rotation center of the rotating frame and the deceleration unit is disposed in the radial structure with respect to the output member of the driving motor, so that the rotating frame may be guided through more stable rotation, the utilisation of space for the installation of parts may be increased, and the overall size of the swivel seat may be made compact.

The above description is intended merely to illustrate the technical spirit of the present invention. Those of ordinary skill in the art to which the present invention pertains may make various modifications and variations without departing from the essential characteristics of the present invention. Accordingly, the embodiments disclosed in the present application are not intended to limit the technical spirit of the present invention, but is intended to illustrate the technical spirit of the present invention. The scope of the technical spirit of the present invention is not limited to these embodiments. Therefore, the scope of protection of the present invention should be interpreted by the attached claims, and all technical spirits falling within the range equivalent to the attached claims should be construed as being included in the scope of the present invention.

What is claimed is:

1. A power driving module for a swivel seat, the power driving module rotatably driving a rotating frame with respect to a fixed frame, comprising:
a driving motor installed on the fixed frame;
a deceleration unit configured to decelerate and transmit a provided driving force in conjunction with the driving motor; and
a ring gear configured to rotate the rotating frame in a forward or reverse direction in conjunction with the deceleration unit;
wherein the driving motor comprises a hollow output member disposed coaxially with a rotation center of the rotating frame, the ring gear is disposed concentrically with the rotation center of the rotating frame, and the deceleration unit is disposed in a radial structure around the output member of the driving motor.

2. The power driving module of claim 1, wherein the fixed frame comprises a base plate provided with a hollow boss portion, the hollow output member comprises a rotor rotatably installed on an outer circumferential surface of the hollow boss portion of the base plate and a stator disposed around the rotor and fixed to the base plate, and the rotor is provided with a first worm gear on an outer circumferential surface thereof to transmit a driving force to the deceleration unit.

3. The power driving module of claim 2, wherein a bearing is installed on the outer circumferential surface of the hollow boss portion of the base plate, and the rotor is rotatably installed on the outer circumferential surface of the hollow boss portion of the base plate via the bearing.

4. The power driving module of claim 2, wherein the deceleration unit comprises:
a first deceleration part configured to firstly decelerate and transmit a rotation of the rotor;
a second deceleration part configured to secondly decelerate and transmit a rotation of the first deceleration part; and
a third deceleration part configured to thirdly decelerate a rotation of the second deceleration part and transmit it to the ring gear.

5. The power driving module of claim 4, wherein:
the first deceleration part comprises a first worm wheel configured to come into external contact with and operate in conjunction with the first worm gear;
the second deceleration part comprises a second worm wheel configured to come into external contact with and operate in conjunction with a second worm gear disposed coaxially with the first worm wheel, and a pinion gear disposed coaxially with the second worm wheel;
the third deceleration part comprises a ring gear configured to come into external contact with and operate in conjunction with the pinion gear; and
the ring gear is disposed on a bottom surface of the load support member to be disposed concentrically with the rotation center of the rotating frame.

6. The power driving module of claim 5, further comprising a shaft member configured to allow the first worm wheel and the second worm gear to be coaxially disposed;
wherein both ends of the shaft member are rotatably installed onto mounting brackets; and
wherein the mounting brackets are fixed to a housing to which the base plate is coupled.

7. The power driving module of claim 6, wherein the mounting brackets comprise a set screw fastened to adjust an axial position with respect to the shaft member, and the set screw is configured to minimize backlash between the second worm gear and the second worm wheel by variably adjusting an axial position of the shaft member with respect to the mounting brackets.
